(19) United States
(12) Patent Application Publication
(10) Pub. No.: US 2014/0313167 A1
(43) Pub. Date: Oct. 23, 2014

(54) MOVING CONTENT BETWEEN DEVICES USING GESTURES

(71) Applicant: Google, Inc., (US)

(72) Inventors: Gabriel Cohen, Alameda, CA (US); Jeremy Lyon, London (GB); Michael Andrew Cleron, Menlo Park, CA (US); Matias Gonzalo Duarte, Mountain View, CA (US)

(73) Assignee: Google, Inc., Mountain View, CA (US)

(21) Appl. No.: 13/867,189

(22) Filed: Apr. 22, 2013

(51) Int. Cl. G06F 3/042

(52) U.S. Cl. CPC G06F 3/0426
USPC 345/175; 345/173

(57) ABSTRACT

A method may include, in a computing device with a touch screen, memory and at least one processor, detecting at least one gesture event associated with the computing device, while consuming multimedia data. Upon detecting the at least one gesture event, at least one multimedia device located in a direction of the at least one gesture event and communicatively coupled to the computing device in a wireless network may be detected. At least a portion of the multimedia data may be communicated using the wireless network, to the at least one multimedia device, for consumption at the at least one multimedia device. Detecting the at least one gesture event may include detecting a finger swipe gesture from an edge of the touch screen and in an inward direction towards the touch screen.

### BACKGROUND

People use a variety of computing devices (smart phones, mobile phones, tablets and/or other mobile devices) during the course of a day, but the content for those devices does not pass easily from device to device. In instances when transfer of content from device to device is possible, it is usually a long and cumbersome process as it requires user manipulation of multiple dialog boxes and menus.

Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

A system and/or method is provided for moving content between devices using gestures, substantially as shown in and/or described in connection with at least one of the figures, as set forth more completely in the claims.

In accordance with an example embodiment of the disclosure, a method may include, in a computing device with a touch screen, memory and at least one processor, detecting at least one gesture event associated with the computing device, while consuming multimedia data. Upon detecting the at least one gesture event, at least one multimedia device located in a direction of the at least one gesture event and communicatively coupled to the computing device in a wireless network may be detected. At least a portion of the multimedia data may be communicated using the wireless network, to the at least one multimedia device, for consumption at the at least one multimedia device. Detecting the at least one gesture event may include detecting a finger swipe gesture from an edge of the touch screen and in an inward direction towards the touch screen.

In accordance with another example embodiment of the disclosure, a system may include a computing device with a touch screen, memory and at least one processor. The at least one processor may be operable to detect at least one gesture event associated with the computing device, while consuming multimedia data. Upon detecting the at least one gesture event, the at least one processor may detect at least one multimedia device located in a direction of the at least one gesture event and communicatively coupled to the computing device in a wireless network. At least a portion of the multimedia data may be communicated using the wireless network, to the at least one multimedia device, for consumption at the at least one multimedia device.

In accordance with yet another example embodiment of the disclosure, a method may include, in a computing device with a touch screen, a camera, memory and at least one processor, authenticating the computing device on a wireless network communicatively coupling a plurality of multimedia devices. While consuming multimedia data, at least one gesture event performed in front of the camera of the computing device may be detected, while the multimedia devices are in view of the camera. Upon detecting the at least one gesture event, a selection of one of the plurality of multimedia devices may be indicated on the touch screen, the selection based on a direction of the at least one gesture event. A confirmation of the selected one of the plurality of devices may be received via the touch screen. At least a portion of the multimedia data may be communicated using the wireless network to the selected one of the plurality of multimedia devices, for consumption at the selected multimedia device.

These and other advantages, aspects and features of the present disclosure, as well as details of illustrated implementation(s) thereof, will be more fully understood from the following description and drawings.

### BRIEF DESCRIPTION OF THE DRAWINGS

FIG. 1 is a block diagram illustrating example architecture with a computing device operable to move content between devices using gestures, in accordance with an example embodiment of the disclosure.

FIG. 2 is a block diagram of the computing device of FIG. 1, in accordance with an example embodiment of the disclosure.

FIG. 3 is a flow chart illustrating example steps of a method for moving content between devices using gestures, in accordance with an example embodiment of the disclosure.

FIG. 4 is a flow chart illustrating example steps of another method for moving content between devices using gestures, in accordance with an example embodiment of the disclosure.

FIG. 5 is a flow chart illustrating example steps of yet another method for moving content between devices using gestures, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations. As utilized herein, the term “processor” may be used to refer to one or more of a central processing unit, a processor of a symmetric or asymmetric multiprocessor system, a digital signal processor, a micro-controller, a graphics/video processor, or another type of processor.

The present disclosure relates to a method and system for moving content between devices using gestures. In various implementations, one or more gestures may be defined for use with a computing device. For example, one or more gestures may be interpreted (or detected) by the device touch screen. One or more other gestures may be camera-based and may be detected by the device camera (e.g., a hand movement in front of the device may be detected by the camera. Additionally, other gestures may be detected by the device GPS sensor, accelerometer and/or any other device sensor. The computing device may detect one or more gesture while content is being consumed on the device (e.g., while a video is being watched or music is playing back on the device). Upon detecting the gesture, one or more other devices may be selected based on the gesture. Content that is currently being consumed at the computing device may then be transferred for consumption at the selected other device.

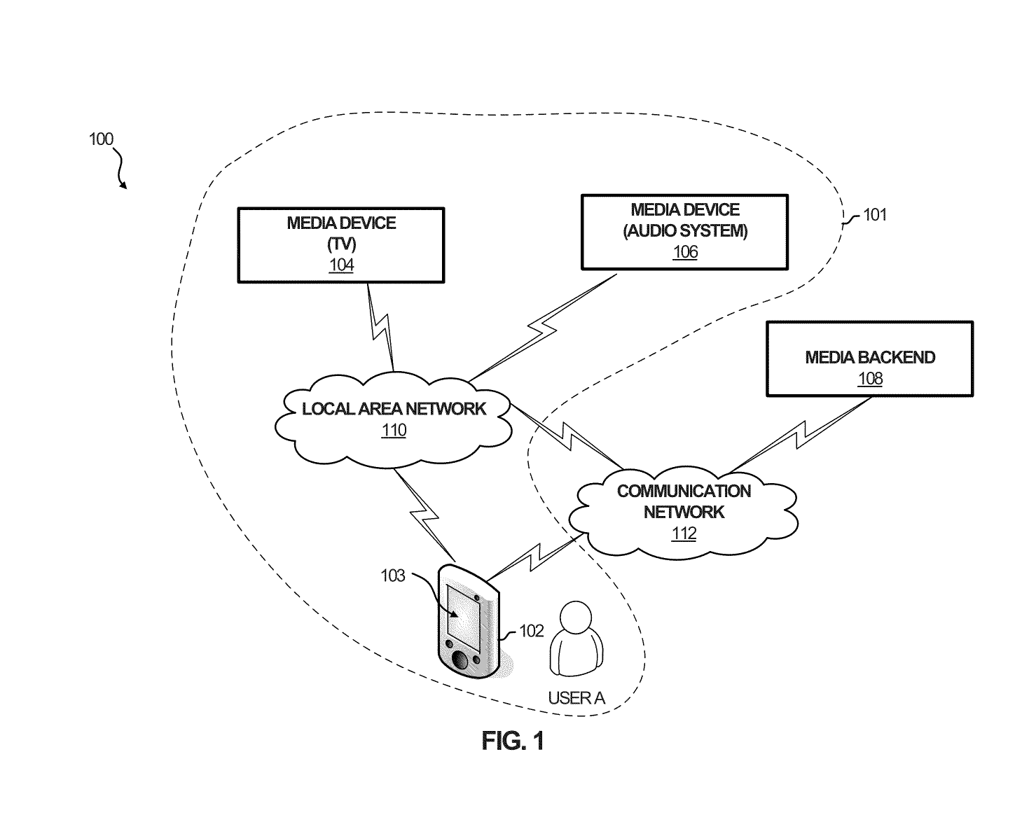

FIG. 1 is a block diagram illustrating example architecture with a computing device operable to move content between devices using gestures, in accordance with an example embodiment of the disclosure. Referring to FIG. 1, the example architecture 100 may comprise a computing device 102 of user A (such as a smart phone, a mobile phone, a tablet and/or another mobile device), media devices 104, 106, and a media backend 108. The media devices 104, 106 may comprise suitable circuitry, logic and/or code and may be operable to consume (e.g., display and/or playback) digital media, such as videos, TV shows, music, photos, books, and other digital media. In this regard, the media device 104 may be a television, and the media device 106 may be an audio system.

Additionally, the computing device 102 and the media devices 104, 106 may be communicatively coupled via a local area network (LAN) 110, which may be a wired and/or a wireless LAN for location 101 (e.g., a home location of user A or another location that user A is visiting). In this regard, the computing device 102 and the media devices 104, 106 may all be configured to support one or more wired protocols (e.g., Ethernet standards, MOCA, etc.) and/or wireless protocols or interfaces (e.g., CDMA, WCDMA, TDMA, GSM, GPRS, UMTS, EDGE, EGPRS, OFDM, TD-SCDMA, HSDPA, LTE, WiMAX, WiFi, Bluetooth, and/or any other available wireless protocol/interface) for communication of data (e.g., digital multimedia data).

The media backend 108 may comprise suitable circuitry, logic and/or code and may be operable to provide digital media related services to the client device 102 (and/or the media devices 104, 106) via the communication network 112 and/or the LAN 110. For example, the media backend 106 may provide digital media storage and management services, subscription services (e.g., streaming media subscription services), and digital media provisioning services (e.g., automatically generating playlists from a digital media library, as well as sale, transcoding and download of digital media, such as video and or audio digital content). The media backend 106 may operate as, for example, a streaming content provider and may be operable to keep track of each digital media item that a user (e.g., user A) has viewed or listened to (e.g., by maintaining a digital media locker associated with user A). Even though the media backend 106 is illustrated as being separate from the user device 102, the disclosure may not be limited in this regard. More specifically, the media backend 106 may be implemented as part of the user device 102 or another computing device of user A.

In operation, the user A may be in location 101 (e.g., home location 101 or visiting location 101 of another user) associated with LAN 110. The user A may use the computing device 102 to receive and consume digital media from the media backend 108 (e.g., a video or a song). Initially, computing device 102 may automatically detect the availability of LAN 110 and if previously authorized (or if no authorization is required), may automatically connect to LAN 110. If prior authorization is required, device 102 may obtain such authorization and connect to the LAN 110 (e.g., enter a password for accessing LAN 110). After connecting to LAN 110, the computing device 110 may be operable to detect other devices (e.g., 104 and/or 106) connected to the same LAN 110 (such devices 104 and/or 106 may be immediately visible to user A (e.g., the same room) or may be located in another area of location 101 (e.g., a different room)).

While consuming the digital media received from the media backend 108, user A may perform a gesture using the computing device 102. In accordance with an example embodiment of the disclosure, one or several gestures may be used in connection with the device 102. The gestures may be used to indicate that digital media content consumed at the device 102 should be transferred for consumption at another device connected to the LAN 110 (or digital media currently consumed at another device should be transferred to computing device 102 for consumption). The gesture may include, for example, a one- or two-fingered swipe from the edge of the touch screen 103 into the touch screen, as though pushing the content from the computing device 102 to another device (e.g., 104 and/or 106). The gesture may also include using the orientation sensor of computing device 102 to detect the device 102 is being turned edge-on to the ground, with an accompanying rapid motion, as though using the device to “throw” the content from the computing device 102 to another device (e.g., 104 and/or 106). The computing device 102 may also use camera-based gesture detection to identify full hand gestures, pushing content from the user's person to another device (e.g., while the camera of device 102 is active, user A may perform a hand gesture in front of the camera is if flicking or swiping content in a direction of another device). Other gestures using the touch-screen 103, orientation sensor, accelerometer, camera and/or other sensor components of device 102 may also be used for purposes of moving content from one device to another. The above described gestures may also be reversible to indicate pulling content that is being consumed at another device (e.g., 104 and/or 106) to the computing device 102.

In instances when there are a total of two or more devices available for sending content to (or receiving content from), the gesture(s) used with computing device 102 may be used to unequivocally indicate device selection. For example, if device 104 and 106 are in the same room as device 102, a “direction” of the gesture may be determined (e.g., a direction of a swiping gesture along the screen 103). In instances when coordinates of devices 104 and 106 are known (e.g., via GPS sensor data), the receiving device may be determined based on the direction of the gesture and the location of the receiving devices.

In instances when location of the receiving devices is not known, a visual confirmation may be provided on screen 103 (e.g., a visual display of available devices) so that user A may select the receiving device. Put another way, in instances when there is more than one possible receiving device, the above gestures may be used to trigger a visual picker that allows user A to select a receiving device. If precise positional information is available for the receiving devices, then no disambiguation may be required since devices that contain a position and facing (compass) can be uniquely identified by determining the direction of the gesture or the direction the computing device 102 is pointed at. After a receiving device is identified, content that is currently being consumed by the computing device 102 may be transferred for consumption at the receiving device (e.g., video being watched on device 102 may be displayed at TV 104, or song played at device 102 may continue playing at audio system 106). After content is transferred for consumption at the receiving device, the computing device 102 may continue consumption of the same content or may stop content consumption altogether.

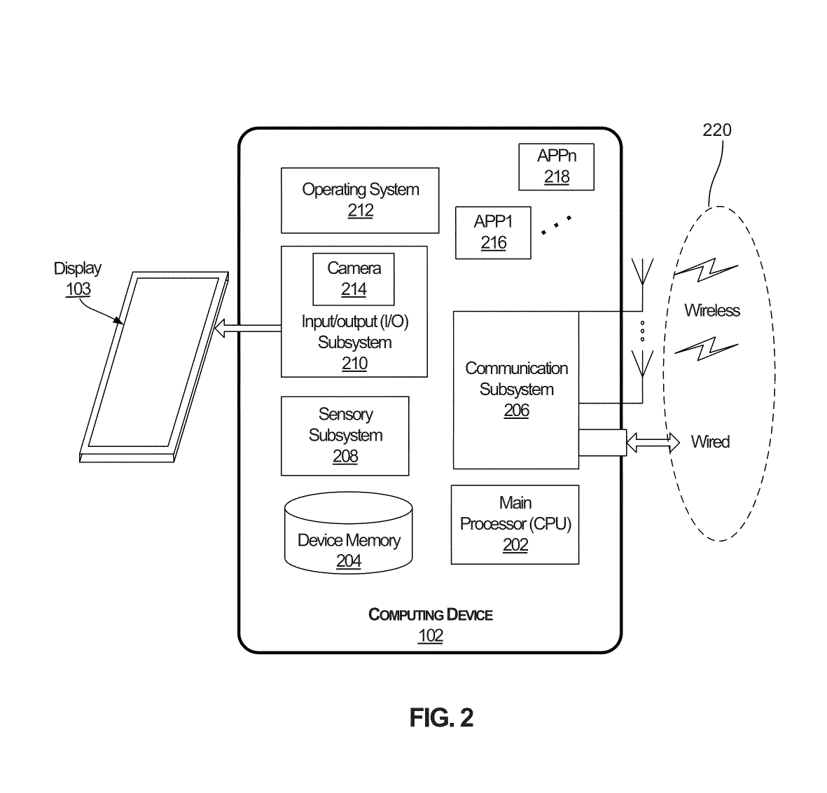

FIG. 2 is a block diagram of the computing device of FIG. 1, in accordance with an example embodiment of the disclosure. Referring to FIG. 2, the computing device 102 may include a handset, a smartphone, a tablet, a laptop, and/or another handheld or portable computing device. The computing device 102 may comprise, for example, a main processor 202, a system memory 204, a communication subsystem 206, a sensory subsystem 208, an input/output (I/O) subsystem 210, and a display 103. The computing device may also comprise an operating system 212 and one or more applications 216, . . . , 218 running on the computing device 102.

The main processor 202 may comprise suitable logic, circuitry, interfaces, and/or code that may be operable to process data, and/or control and/or manage operations of the computing device 102, and/or tasks and/or applications performed therein in connection with the architecture 100. In this regard, the main processor 202 may be operable to configure and/or control operations of various components and/or subsystems of the computing device 102, by utilizing, for example, one or more control signals. The main processor 102 enables running and/or execution of applications, programs and/or code, which may be stored, for example, in the system memory 204. Alternatively, one or more dedicated application processors may be utilized for running and/or executing applications (or programs) in the computing device 100.

In some instances, one or more of the applications 216, . . . , 218 running and/or executing on the computing device 102 may generate and/or update video content that may be rendered via the display 103.

The system memory 204 may comprise suitable logic, circuitry, interfaces, and/or code that may enable permanent and/or non-permanent storage, buffering, and/or fetching of data, code and/or other information, which may be used, consumed, and/or processed. In this regard, the system memory 204 may comprise different memory technologies, including, for example, read-only memory (ROM), random access memory (RAM), Flash memory, solid-state drive (SSD), and/or field-programmable gate array (FPGA). The system memory 204 may store, for example, configuration data, which may comprise parameters and/or code, comprising software and/or firmware (e.g., the operating system 212 and/or the one or more applications 216, . . . , 218).

The communication subsystem 206 may comprise suitable logic, circuitry, interfaces, and/or code operable to communicate data from and/or to the computing device, such as via one or more wired and/or wireless connections 220. The communication subsystem 206 may be configured to support one or more wired protocols (e.g., Ethernet standards, MOCA, etc.) and/or wireless protocols or interfaces (e.g., CDMA, WCDMA, TDMA, GSM, GPRS, UMTS, EDGE, EGPRS, OFDM, TD-SCDMA, HSDPA, LTE, WiMAX, WiFi, Bluetooth, and/or any other available wireless protocol/interface), facilitating transmission and/or reception of signals to and/or from the computing device 102, and/or processing of transmitted or received signals in accordance with applicable wired or wireless protocols. In this regard, signal processing operations may comprise filtering, amplification, analog-to-digital conversion and/or digital-to-analog conversion, up-conversion/down-conversion of baseband signals, encoding/decoding, encryption/decryption, and/or modulation/demodulation. In accordance with an embodiment of the disclosure, the communication subsystem 206 may provide wired and/or wireless connections to, for example, the media backend 108 (via the communication network 112 which may include the Internet) and/or one or more media devices such as 104 and/or 106 within the location 101 (via the LAN 110) using the wired and/or wireless connections 220.

The sensory subsystem 208 may comprise suitable logic, circuitry, interfaces, and/or code for obtaining and/or generating sensory information, which may relate to the computing device 102, its user(s), and/or its environment. For example, the sensory subsystem 208 may comprise positional or locational sensors (e.g., GPS or other GNSS based sensors), ambient conditions (e.g., temperature, humidity, or light) sensors, and/or motion related sensors (e.g., accelerometer, gyroscope, pedometers, and/or altimeters). In some instances, one or more of the sensors within the sensory subsystem 208 (with or without the use of camera 214) may be used during a gesture, for purposes of indicating desire to transfer content between devices (e.g., to indicate that transfer of content is desired, to indicate a direction where the receiving device is located, to initiate an optical selector/interface for selecting a receiving device, as well as other uses as described herein for facilitating the transfer of content).

The I/O subsystem 210 may comprise suitable logic, circuitry, interfaces, and/or code for enabling user interactions with the computing device 102, enabling obtaining input from user(s) and/or to providing output to the user(s). The I/O subsystem 210 may support various types of inputs and/or outputs, including, for example, video, audio, and/or textual. In this regard, dedicated I/O devices and/or components, external to or integrated within the computing device 102, may be utilized for inputting and/or outputting data during operations of the I/O subsystem 210. Example I/O devices may comprise the camera 214, displays, mice, keyboards, touchscreens, voice input interfaces, and other input/output interfaces or devices. With respect to video outputs, the I/O subsystem 210 may be operable to generate and/or process video content, graphics, and/or textual data, and/or generate video frames based thereon for display, via the display 103 for example.

The display 103 may comprise suitable logic, circuitry, interfaces and/or code that may enable displaying of video content, which may be handled and/or processed via the I/O subsystem 110. The display 103 may include a touch-screen and may be used in outputting video data.

The operating system 212 may include software that is used to manage the various hardware resources of the computing device 102. The operating system 212 may also be used to provide common services to computer programs or applications, such as the one or more applications 216, . . . , 218. The operating system 212 may act as an intermediary between the hardware components and the one or more applications 216, . . . , 218.

The one or more applications 216, . . . , 218 may include one or more software applications (i.e., computer programs) that may help a user of the computing device 100 perform a specific task. For example, a software application may include an interactive application that displays content to a user and allows the user to provide input as to the manner in which the content is provided and/or the type of content that is provided. To perform a task (e.g., web browsing, video playback, etc.), the one or more applications 216, . . . , 218 may access the CPU 202, the memory 204, and/or any other circuit within the computing device 102, as well as the operating system 212.

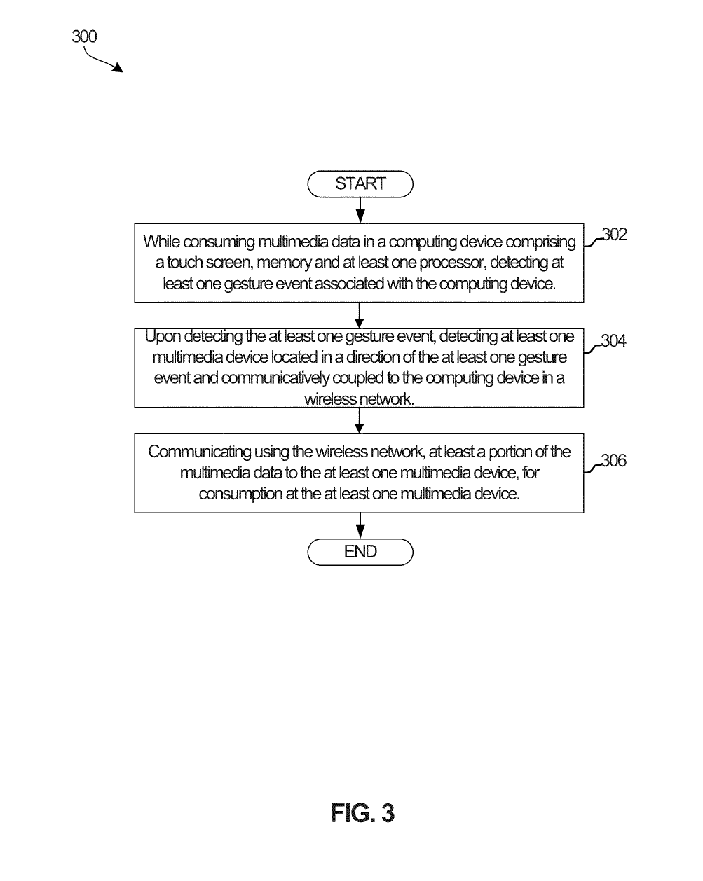

FIG. 3 is a flow chart illustrating example steps of a method for moving content between devices using gestures, in accordance with an example embodiment of the disclosure. Referring to FIGS. 1-3, the example method 300 may start at 302, when the computing device 102 (which includes a touch screen 103, memory 204 and at least one processor 202) may detect at least one gesture event associated with the computing device 102, while the device 102 is consuming multimedia data. At 304, upon detecting the at least one gesture event, the device 102 may detect at least one multimedia device (e.g., 104 and/or 106) located in a direction of the at least one gesture event and communicatively coupled to the computing device in a wireless network (e.g., LAN 110). At 306, at least a portion of the multimedia data may be communicated using the wireless network (LAN 110) to the at least one multimedia device (e.g., 104 and/or 106), for consumption at the at least one multimedia device.

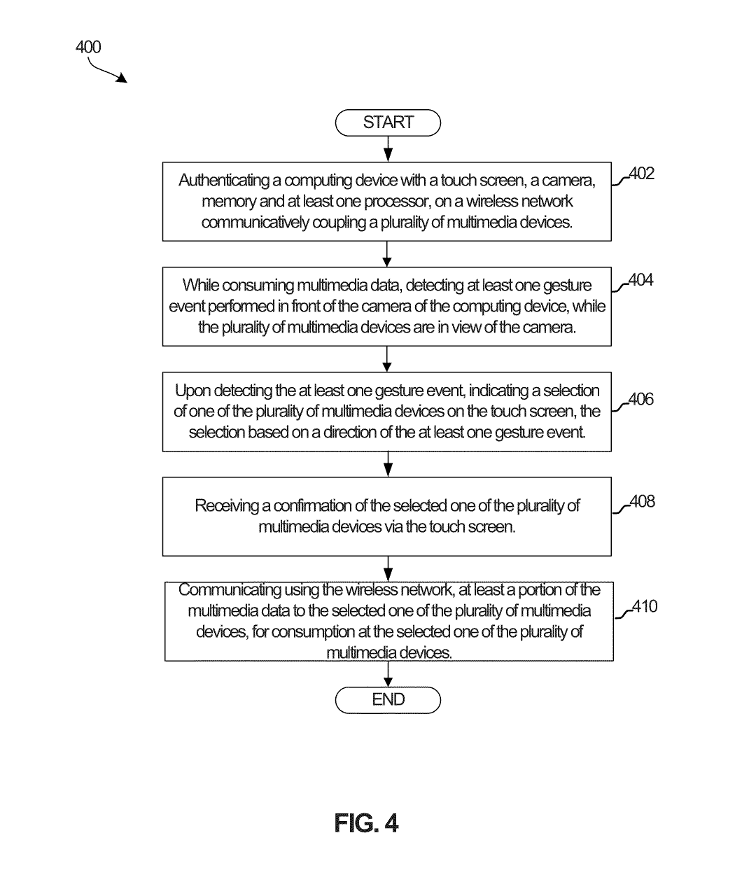

FIG. 4 is a flow chart illustrating example steps of another method for moving content between devices using gestures, in accordance with an example embodiment of the disclosure. Referring to FIGS. 1-2 and 4, the example method 400 may start at 402, when a computing device (e.g., 102) with a touch screen (e.g., 103), a camera (e.g., 214), memory (e.g., 204) and at least one processor (e.g., 202), may be authenticated on a wireless network (e.g., LAN 110) communicatively coupling a plurality of multimedia devices (e.g., 104 and 106). Such authentication may take place automatically and without user intervention (e.g., if the computing device 102 has previously been authenticated on the LAN 110).

At 404, while consuming multimedia data, the computing device 102 may detect at least one gesture event performed in front of the camera (214) of the computing device 102, while the plurality of multimedia devices (e.g., 104, 106) are in view of the camera. At 406, upon detecting the at least one gesture event, the computing device 102 may indicate a selection of one of the plurality of multimedia devices on the touch screen (e.g., an indication such as a photo or an icon for each of the plurality of multimedia devices in view of the camera). The selection may be based on a direction of the at least one gesture event (e.g., a direction of a swiping gesture on the touch screen 103 or a direction of a gesture detected in front of the camera 214).

At 408, the computing device 102 may receive a confirmation of the selected one of the plurality of multimedia devices via the touch screen. At 410, at least a portion of the multimedia data may be communicated using the LAN 110 to the selected one of the plurality of multimedia devices for consumption at the selected multimedia device.

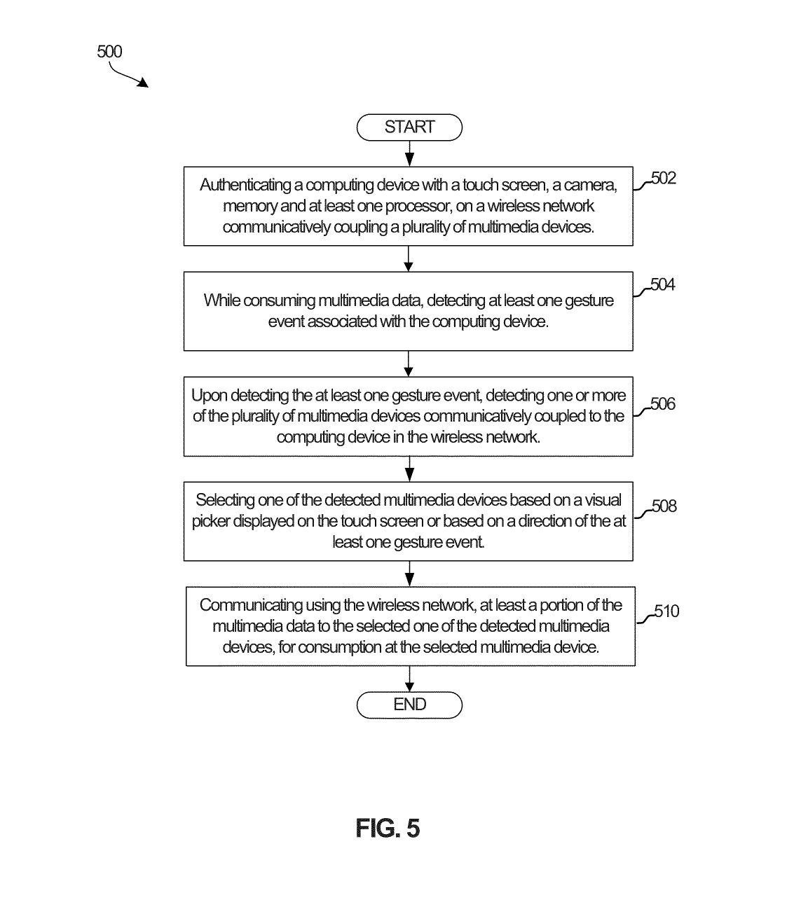

FIG. 5 is a flow chart illustrating example steps of yet another method for moving content between devices using gestures, in accordance with an example embodiment of the disclosure. Referring to FIGS. 1-2 and 5, the example method 500 may start at 502 when a computing device (e.g., 102) with a touch screen (e.g., 103), a camera (e.g., 214), memory (e.g., 204) and at least one processor (e.g., 202), may be authenticated on a wireless network (e.g., LAN 110) communicatively coupling a plurality of multimedia devices (e.g., 104 and 106). Such authentication may take place automatically and without user intervention (e.g., if the computing device 102 has previously been authenticated on the LAN 110).

At 504, while consuming multimedia data, the computing device 102 may detect at least one gesture event associated with the computing device 102. At 506, upon detecting the at least one gesture event, the computing device may detect one or more of the plurality of multimedia devices (e.g., 104, 106) communicatively coupled to the computing device in the wireless network (LAN 110). At 508, one of the detected multimedia devices may be selected based on a visual picker displayed on the touch screen (e.g., 103) or based on a direction of the at least one gesture event (e.g., a direction of a swiping gesture on the touch screen 103 or a direction of a gesture detected in front of the camera 214). At 510, at least a portion of the multimedia data may be communicated using the LAN 110 to the selected one of the plurality of multimedia devices for consumption at the selected multimedia device.

Other implementations may provide a machine-readable storage device, having stored thereon, a machine code and/or a computer program having at least one code section executable by a machine and/or a computer, thereby causing the machine and/or computer to perform the steps as described herein for moving content between devices using gestures.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
in a computing device comprising a touch screen, memory and at least one processor:
while consuming multimedia data, detecting at least one gesture event associated with the computing device;
upon detecting the at least one gesture event, detecting at least one multimedia device located in a direction of the at least one gesture event and communicatively coupled to the computing device in a wireless network; and
communicating using the wireless network, at least a portion of the multimedia data to the at least one multimedia device, for consumption at the at least one multimedia device.

2. The method according to claim 1, wherein detecting the at least one gesture event comprises:
detecting a finger swipe gesture from an edge of the touch screen and in an inward direction towards the touch screen.

3. The method according to claim 1, wherein detecting the at least one gesture event comprises:
detecting, during a first component of the at least one gesture, the computing device is turned edge-on towards a horizontal surface, wherein a horizontal plane of the touch screen remaining substantially parallel with a vertical axis, and a long edge of the touch screen is substantially perpendicular to the vertical axis;
detecting, during a second component of the at least one gesture, the device is turned edge-on towards the horizontal surface, wherein the long edge of the touch screen is substantially parallel to the vertical axis; and
detecting, during a third component of the at least one gesture, the computing device is turned edge-on towards the horizontal surface, wherein the long edge of the touch screen is substantially perpendicular to the vertical axis.

4. The method according to claim 1, wherein detecting the at least one gesture event comprises:
detecting at least one hand gesture using a camera of the computing device.

5. The method according to claim 1, wherein the multimedia data comprises at least one of audio stream data, video content data, and photographic content data.

6. The method according to claim 1, comprising:
authenticating the computing device on the wireless network.

7. The method according to claim 6, comprising:
if the wireless network comprises an unsecured wireless network, automatically authenticating the computing device on the wireless network; and
if the wireless network comprises a secured wireless network, authenticating the computing device on the wireless network using at least one authentication user interface displayed on the touch screen.

8. The method according to claim 1, comprising:
if the at least one multimedia device comprises a plurality of devices coupled to the wireless network:
determining positional information for each of the plurality of devices;
selecting one of the plurality of devices based on the direction associated with the at least one gesture event; and
communicating using the wireless network, the at least a portion of the multimedia data to the selected one of the plurality of devices, for consumption at the selected one of the plurality of devices.

9. The method according to claim 8, comprising:
if positional information for each of the plurality of devices is not available:
displaying an user interface comprising at least one visual indication for each of the plurality of devices;
selecting one of the plurality of devices using the at least one visual indication; and
communicating using the wireless network, the at least a portion of the multimedia data to the selected one of the plurality of devices, for consumption at the selected one of the plurality of devices.

10. The method according to claim 1, comprising:
upon detecting of the at least one multimedia device communicatively coupled to the computing device in a wireless network, requesting communication of multimedia data from the at least one multimedia device to the computing device.

11. A system, comprising:
a computing device comprising a touch screen, memory and at least one processor, the at least one processor operable to:
while consuming multimedia data, detect at least one gesture event associated with the computing device;
upon detecting the at least one gesture event, detect at least one multimedia device located in a direction of the at least one gesture event and communicatively coupled to the computing device in a wireless network; and
communicate using the wireless network, at least a portion of the multimedia data to the at least one multimedia device, for consumption at the at least one multimedia device.

12. The system according to claim 10, wherein the at least one processor is operable to:
detect a finger swipe gesture from an edge of the touch screen and in an inward direction towards the touch screen.

13. The system according to claim 10, wherein the at least one processor is operable to:
detect, during a first component of the at least one gesture, the computing device is turned edge-on towards a horizontal surface, wherein a horizontal plane of the touch screen remaining substantially parallel with a vertical axis, and a long edge of the touch screen is substantially perpendicular to the vertical axis;
detect, during a second component of the at least one gesture, the device is turned edge-on towards the horizontal surface, wherein the long edge of the touch screen is substantially parallel to the vertical axis; and
detect, during a third component of the at least one gesture, the computing device is turned edge-on towards the horizontal surface, wherein the long edge of the touch screen is substantially perpendicular to the vertical axis.

14. The system according to claim 10, wherein the at least one processor is operable to:
detect at least one hand gesture using a camera of the computing device.

15. The system according to claim 10, wherein the multimedia data comprises at least one of audio stream data, video content data, and photographic content data.

16. The system according to claim 10, wherein the at least one processor is operable to:
if the wireless network comprises an unsecured wireless network, automatically authenticate the computing device on the wireless network; and
if the wireless network comprises a secured wireless network, authenticate the computing device on the wireless network using at least one authentication user interface displayed on the touch screen.

17. The system according to claim 10, wherein the at least one processor is operable to:
if the at least one multimedia device comprises a plurality of devices coupled to the wireless network:
determine positional information for each of the plurality of devices;
select one of the plurality of devices based on the direction associated with the at least one gesture event; and
communicate using the wireless network, the at least a portion of the multimedia data to the selected one of the plurality of devices, for consumption at the selected one of the plurality of devices.

18. The system according to claim 17, wherein the at least one processor is operable to:
if positional information for each of the plurality of devices is not available:
display an user interface comprising at least one visual indication for each of the plurality of devices;
select one of the plurality of devices using the at least one visual indication; and
communicate using the wireless network, the at least a portion of the multimedia data to the selected one of the plurality of devices, for consumption at the selected one of the plurality of devices.

19. The system according to claim 10, wherein the at least one processor is operable to:
upon detecting of the at least one multimedia device communicatively coupled to the computing device in a wireless network, request communication of multimedia data from the at least one multimedia device to the computing device.

20. A method, comprising:
in a computing device comprising a touch screen, a camera, memory and at least one processor:
authenticating the computing device on a wireless network communicatively coupling a plurality of multimedia devices;
while consuming multimedia data, detecting at least one gesture event performed in front of the camera of the computing device, while the plurality of multimedia devices are in view of the camera;
upon detecting the at least one gesture event, indicating a selection of one of the plurality of multimedia devices on the touch screen, the selection being based on a direction of the at least one gesture event;
receiving a confirmation of the selected one of the plurality of multimedia devices via the touch screen; and
communicating using the wireless network, at least a portion of the multimedia data to the selected one of the plurality of multimedia devices, for consumption at the selected one of the plurality of multimedia devices.
